(19) United States
(12) Patent Application Publication
(10) Pub. No.: US 2026/0050695 A1
(43) Pub. Date: Feb. 19, 2026

(54) SEMICONDUCTOR SYSTEM INCLUDING A PLURALITY OF DIES AND METHOD FOR VERIFYING SECURITY BETWEEN THE PLURALITY OF DIES

(71) Applicant: SAMSUNG ELECTRONICS CO., LTD., Suwon-si (KR)

(72) Inventors: Keunyoung Park, Suwon-si (KR); Eunsung Lee, Suwon-si (KR); Dongjin Park, Suwon-si (KR); Jaeyong Lee, Suwon-si (KR)

(21) Appl. No.: 19/196,344

(22) Filed: May 1, 2025

(30) Foreign Application Priority Data
Aug. 19, 2024 (KR) 10-2024-0110292

(51) Int. Cl. G06F 21/72; G06F 21/44; G06F 21/60

(52) U.S. Cl. CPC G06F 21/72; G06F 21/44; G06F 21/606

(57) ABSTRACT

A semiconductor system includes a first die, including a first security processor configured to store a shared key and an application processor, and a second die connected to the first die through a first channel and including a second security processor configured to store the shared key. The application processor may transmit a security request to the first security processor in response to a request for a security-required operation of the second die. The first security processor, in response to the security request, may be configured to generate an authentication code based on the shared key and transmit a security message, including a command corresponding to the security-required operation of the second die and the authentication code, to the second security processor through the first channel. The second security processor may determine whether the security message has been tampered with, using the authentication code and the shared key.

### CROSS-REFERENCE TO RELATED APPLICATION(S)

This application claims priority to Korean Patent Application No. 10-2024-0110292, filed in the Korean Intellectual Property Office on Aug. 19, 2024, the disclosure of which is herein incorporated by reference in its entirety.

### BACKGROUND

With the recent trend toward increasing integration and miniaturization of semiconductor devices, extensive research has been focused on improving the yield and efficiency of semiconductor fabrication processes. In some examples, chiplet-based system-on-chip (SoC) architectures are used in which two or more dies are individually manufactured and subsequently interconnected during packaging to form a unified chip.

In these chiplet-based architectures, a plurality of interconnected dies communicate with each other through high-speed serial interfaces, such as Peripheral Component Interconnect Express (PCIe) or Universal Chiplet Interconnect Express (UCIe).

Communication channels between the plurality of dies may be implemented on an external substrate or other components.

### SUMMARY

In general, the present disclosure is directed toward a semiconductor system for improving security of communication between dies.

According to some implementations, the present disclosure is directed to a semiconductor system that includes a first die, including a first security processor configured to store a shared key and an application processor, and a second die connected to the first die through a first channel and including a second security processor configured to store the shared key. The application processor may transmit a security request to the first security processor in response to a request for a security-required operation of the second die. The first security processor, in response to the security request, may be configured to generate an authentication code based on the shared key and transmit a security message, including a command corresponding to the security-required operation of the second die and the authentication code, to the second security processor through the first channel. The second security processor may determine whether the security message has been tampered with, using the authentication code and the shared key.

According to some implementations, the present disclosure is directed to a method for verifying security that includes generating an authentication code, based on a prestored shared key, by a first security processor included in a first die in response to the first die receiving an operation request for a security-required operation of the second die, transmitting, by the first security processor, a security message to a second security processor included in the second die through a first channel, the security message including a command corresponding to the security-required operation and the authentication code, determining, by the second security processor, whether the security message has been tampered with, using a prestored shared key and the authentication code, and performing, by the second security processor, the security-required operation based on the command when it is determined that the security message has not been tempered with.

According to some implementations, the present disclosure is directed to a system-on-chip (SoC), including a plurality of dies connected to each other through a substrate, that includes a first die including a first security processor configured to store a shared key and an application processor and a second die connected to the first die through a first channel and including a second security processor configured to store the shared key. The application processor may transmit a first security request to the first security processor in response to a first operation request for a first operation to set a security level of a first intellectual property (IP) block included in the second die. The first security processor, in response to the first security request, may be configured to generates an authentication code based on the shared key, generate a first security message comprising a first command corresponding to the first operation and the authentication code, and transmit the first security message to the second security processor through the first channel. The second security processor determines whether the first security message has been tampered with, using the authentication code and the shared key.

### BRIEF DESCRIPTION OF DRAWINGS

Example implementations will be more clearly understood from the following detailed description, taken in conjunction with the accompanying drawings.

FIG. 1 is a block diagram illustrating an example configuration of a semiconductor system according to some implementations.

FIG. 2 is a cross-sectional view of an examples of semiconductor system according to some implementations.

FIG. 3 is a block diagram illustrating an example configuration of a security processor included in a die according to some implementations.

FIG. 4A is a diagram illustrating an example configuration, in which a second die sets the security level for a first IP block in response to a first request, according to some implementations.

FIG. 4B is a diagram illustrating an example configuration, in which a second die generates a security key for a first IP block in response to a second request, according to some implementations.

FIG. 5 is a diagram illustrating an example configuration in which data is transmitted to a second IP block of a second die in response to a third request according to some implementations.

FIG. 6 is a diagram illustrating an example configuration, in which a first security processor verifies the security of a second die in response to a fourth request according to some implementations.

FIG. 7 is a diagram illustrating examples of messages and requests exchanged by an application processor, a first security processor, and a second security processor in response to a fourth request according to some implementations.

FIG. 8 is a diagram illustrating an example configuration to operate a third IP block of a second die in response to a fifth request according to some implementations.

FIG. 9 is a diagram illustrating an example configuration to operate a second communication controller of a second die in response to a fifth request according to some implementations.

FIG. 10 is a flowchart illustrating an example of a method for verifying security between interconnected dies according to some implementations.

FIG. 11 is a flowchart illustrating an example of a method by which a second security processor verifies whether a security message transmitted from a first die has been tampered with according to some implementations.

FIG. 12 is a flowchart illustrating an example of a method by which a first die verifies the security of a second die according to some implementations.

### DETAILED DESCRIPTION

Hereinafter, example implementations will be explained in detail with reference to the accompanying drawings.

The term “first,” “second,” or the like used herein may modify various elements regardless of the order and/or priority thereof, and is used only for distinguishing one element from another element, without limiting some implementations.

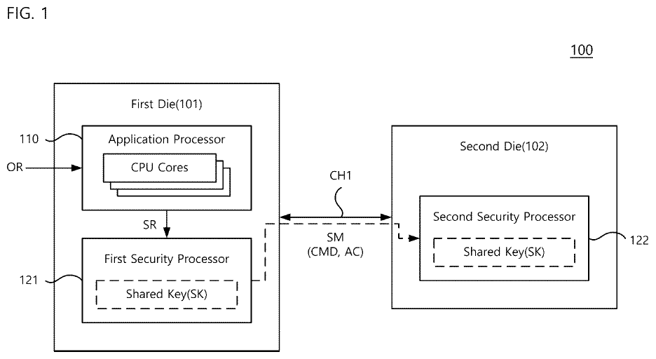

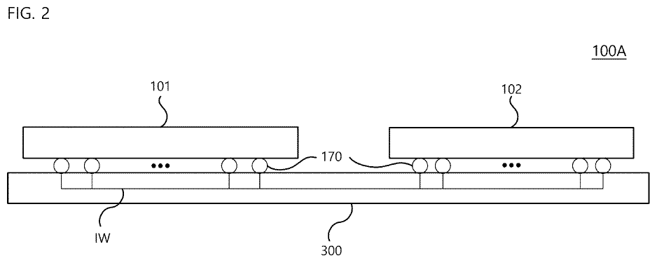

FIG. 1 is a block diagram illustrating an example configuration of a semiconductor system according to some implementations, and FIG. 2 is a cross-sectional view of an example of a semiconductor system according to some implementations. In FIG. 1, a semiconductor system 100 may include a first die 101 and a second die 102. The semiconductor system 100 may be included in, for example, a server, a computer, a smartphone, a tablet, a personal digital assistant (PDA), a digital camera, a portable multimedia player (PMP), a wearable device, an Internet of Things (IoT) device, a smart speaker, or an automotive system, but the present disclosure is not limited thereto.

For example, the semiconductor system 100 may include a first die 101 and a second die 102 that exchange messages through a first channel CH1. For example, the message may include at least a portion of a command, data, header, identifier, and code, but example embodiments are not limited thereto.

For example, the first channel CH1 may be understood as a communication channel through a high-speed serial interface, such as Peripheral Component Interconnect Express (PCIe) or Universal Chiplet Interconnect Express (UCIe).

In FIG. 2, the semiconductor system 100A may include a first die 101 and a second die 102 disposed on a substrate 300. For example, the first die 101 and the second die 102 may be mounted on the substrate 300 through a plurality of bumps 170 on the substrate 300.

According to some implementations, the first die 101 and the second die 102 may be disposed on a first surface of the substrate 300. For example, the first die 101 may be disposed on a first surface of the substrate 300, and the second die 102 may be disposed on a second surface parallel to the first surface of the substrate 300.

The first die 101 and the second die 102 may be connected through the substrate 300. For example, the first die 101 and the second die 102 may be connected through at least one internal wiring IW formed within the substrate 300.

For example, the first die 101 and the second die 102 may exchange data or messages through the internal wiring IW formed on the substrate 300.

For example, the semiconductor system 100A may have a structure in which a plurality of dies 101 and 102 are disposed on the substrate 300 and connected to each other. For example, the semiconductor system 100A may be understood as having a chiplet structure.

The semiconductor system 100A may be referred to as a system-on-chip (SoC) including a plurality of dies 101 and 102. However, the semiconductor system 100A illustrated in FIG. 2 may be referred to as an example of the semiconductor system 100 illustrated in FIG. 1. Accordingly, the configuration (or structure) of the semiconductor system 100 is not limited to the semiconductor system 100A illustrated in FIG. 2.

In FIG. 1, the first die 101 may include an application processor 110 and a first security processor 121. However, the configuration of the first die 101 illustrated in FIG. 1 is merely exemplary, and the first die 101 may further include a graphics processing unit (GPU), a codec, a scaler, a display controller, an access controller, or the like.

The first die 101 may include an application processor 110 controlling the operation of the first die 101. The application processor 110 may execute software or programs to control at least one other component of the semiconductor system 100 (for example, the first security processor 121 and/or the second die 102) and perform various data processing or calculations. The application processor 110 may include a central processing unit, a microprocessor, or the like, and may control the overall operation of the semiconductor system 100. Accordingly, the operations performed by the semiconductor system 100 may be understood as being performed under the control of the application processor 110.

The application processor 110 may include a plurality of CPU cores. Each of the plurality of CPU cores may be a processing unit supporting TrustZone and may be, for example, an ARM core. Hereinafter, an example will be provided in which the application processor 110 includes an ARM core.

According to some implementations, the application processor 110 may include an algorithm for controlling the first security processor 121. For example, the algorithm may be implemented as software code programmed in the application processor 110 or may be hardcoded in the application processor 110. However, the present disclosure is not limited thereto.

Depending on the algorithm, the application processor 110 may transmit a security request SR to the first security processor 121 in response to an operation request OR. For example, the application processor 110 may transmit a security request SR to the first security processor 121 in response to receiving an operation request OR for a security-required security.

The first die 101 may include a first security processor 121 storing a shared key SK. For example, the first security processor 121 may generate an authentication code AC using a prestored shared key SK in response to a security request SR transmitted from the application processor 110.

The first security processor 121 may generate a security message SM including a command CMD corresponding to an operation requested by the operation request OR and an authentication code AC. For example, the security message SM may further include at least a portion of data and an identifier, but the present disclosure is not limited thereto. The first security processor 121 may transmit the security message SM to the second security processor 122 through a first channel CH1.

The semiconductor system 100 may include a second die 102 connected to the first die 101 through the first channel CH1. For example, the semiconductor system 100 may include a second die 102 including a second security processor 122. The second die 102 may include a second security processor 122 storing a shared key SK. The shared key SK stored in the second security processor 122 may be referred to as substantially the same as the shared key SK stored in the first security processor 121. The shared key SK may be stored in (or injected into) each of the first security processor 121 and the second security processor 122 using a one-time programmable (OTP) memory.

According to some implementations, the second security processor 122 may verify whether the security message SM has been tampered with, using a prestored shared key SK. For example, the second security processor 122 may generate a decoding code from components of the security message SM, excluding the authentication code AC, using the shared key SK. The second security processor 122 may determine whether the decoding code is the same as the authentication code AC included in the security message SM. For example, when the decoding code is the same as the authentication code AC included in the security message SM, the second security processor 122 may determine that the security message SM has not been tampered with. When the decoding code is different from the authentication code AC included in the security message SM, the second security processor 122 may determine that the security message SM has been tampered with.

When it is determined that the security message SM has not been tampered with the second security processor 122 may perform an operation based on the command CMD included in the security message SM. For example, when it is determined that the security message SM has not been tampered with, the second security processor 122 may perform a security-required operation on at least one intellectual property (IP) block included in the second die 102 based on the command CMD. When it is determined that the security message SM has not been tampered with, the second security processor 122 may perform an operation, requested by an operation request OR, on at least one IP block included in the second die 102 based on the command CMD.

Referring to the above-described configuration, the first security processor 121 may transmit a security message SM, including an authentication code AC generated using the prestored shared key SK, to the second security processor 122. In addition, the second security processor 122 may determine whether the security message SM has been tempered with, using the authentication code AC included in the security message SM and the prestored shared key SK. For example, the first die 101 and the second die 102 may exchange a security message SM including an authentication code AC generated based on the shared key SK commonly stored in the security processors 121 and 122 of each die.

As a result, the semiconductor system 100 may prevent an external attack (for example, hacking) on a communication channel (for example, the first channel CH1) between the dies 101 and 102. For example, the semiconductor system 100 may improve the security of communication between the dies 101 and 102.

Referring to the above-described configuration, the semiconductor system 100 may ensure the security of communication between the dies 101 and 102 using an authentication code based on the shared key SK without encrypting the data exchanged between the dies 101 and 102. For example, the semiconductor system 100 may perform communication a security message SM, including an authentication code AC, to significantly reduce a component (or circuit) required to encrypt all pieces of data (or messages) exchanged between the dies 101 and 102. As a result, the semiconductor system 100 may operate with relatively less power compared to a case in which all pieces of data (or messages) exchanged between the dies 101 and 102 are encrypted.

In addition, the semiconductor system 100 may be implemented in a relatively smaller area compared to a case in which all pieces of data (or messages) exchanged between the dies 101 and 102 are encrypted.

In addition, the semiconductor system 100 may perform communication through a security message SM, including an authentication code, to significantly reduce a latency required to encrypt all pieces of data (or messages) exchanged between the dies 101 and 102.

As a result, the semiconductor system 100 may have relatively lower latency compared to a case in which all pieces of data (or messages) exchanged between the dies 101 and 102 are encrypted.

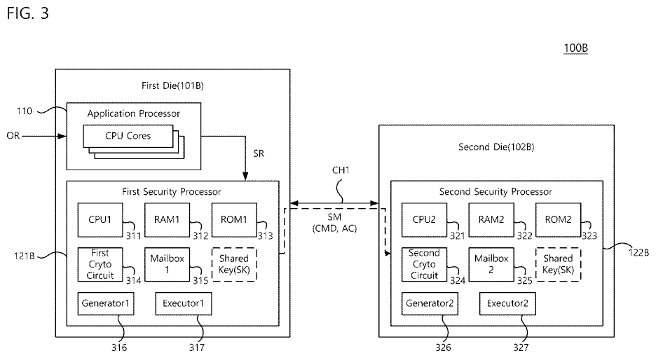

FIG. 3 is a block diagram illustrating an example configuration of a security processor included in a die according to some implementations. In FIG. 3, a semiconductor system 100B may include a first die 101B and a second die 102B. The semiconductor system 100B illustrated in FIG. 3 may be understood as an example of the semiconductor system 100 illustrated in FIG. 1. Accordingly, the same or substantially the same components are represented by the same reference numerals, and redundant descriptions will be omitted to avoid repetition.

The first die 101B may include an application processor 110 and a first security processor 121B. For example, the first die 101B may include a first security processor 121B storing a shared key SK.

The first security processor 121B may include a first CPU 311, a first RAM 312, a first ROM 313, a first cryptographic circuit 314, a first mailbox 315, a first generator 316, and a first execution circuit 317. However, the above-mentioned configuration of the first security processor 121B is merely exemplary, and the first security processor 121B may further include a random number generator.

The first CPU 311 may control the overall operation of the first security processor 121B.

The first RAM 312 may be a volatile memory, such as a static random access memory (SRAM). For example, the first RAM 312 may temporarily store secure data or an authentication code AC. Also, the first RAM 312 may store a timestamp, a nonce, or a counter used for data encryption.

The first ROM 313 may be, for example, a one-time programmable (OTP) memory. According to some implementations, the first ROM 313 may store the shared key SK, necessary for the first cryptographic circuit 314, to generate an authentication code AC.

According to some implementations, the shared key SK may be stored in another storage space within the first security processor 121B.

According to some implementations, the first security processor 121B may communicate with the application processor 110 through an internal first mailbox 315. For example, the first security processor 121B may receive a security request SR from the application processor 110 through the first mailbox 315.

Furthermore, the first security processor 121B may generate an authentication code AC using the prestored shared key SK in response to a security request SR transmitted from the application processor 110. For example, the first cryptographic circuit 314 may generate an authentication code from the prestored shared key SK in response to a security request SR. For example, the first cryptographic circuit 314 may generate an authentication code AC using a cryptographic algorithm, such as HMAC-SHA256 or AES-GMAC, and the shared key SK. Accordingly, the first cryptographic circuit 314 may store a cryptographic algorithm, such as HMAC-SHA256 or AES-GMAC, in the form of software code programmed internally or in the form of hardcoded hardware code. For example, the authentication code AC may be generated from the first cryptographic circuit 314 to include the shared key SK.

In addition, the first security processor 121B may generate a security message SM including an authentication code AC and a command CMD. The command CMD may be understood as corresponding to an operation requested by the operation request OR. For example, the first generator 316 may generate a security message SM including at least portion of a command CMD corresponding to the operation requested by the operation request OR, data, and an identifier, and an authentication code AC.

The first security processor 121B may transmit the security message SM to the second security processor 122B through the first channel CH1.

The first execution circuit 317 may determine whether a message transmitted from an authentication code included in a message transmitted from the second security processor 122B has been tampered with. For example, the first execution circuit 317 may generate a decoding code from the message, transmitted from the second security processor 122B, using the shared key SK.

In addition, the first execution circuit 317 may determine whether the transmitted message has been tampered with, depending on whether the generated decoding code matches an authentication code included in a message transmitted from the second security processor 122B.

The second die 102B may include a second security processor 122B storing a shared key SK. The second security processor 122B may include a second CPU 321, a second RAM 322, a second ROM 323, a second cryptographic circuit 324, a second mailbox 325, a second generator 326, and a second execution circuit 327. However, the above-mentioned configuration of the second security processor 122B is merely exemplary, and the second security processor 122B may further include, for example, a random number generator.

The second CPU 321 may control the overall operation of the second security processor 122B.

The second RAM 322 may be a volatile memory, such as an SRAM. For example, the second RAM 322 may temporarily store a reply authentication code, decoding code, or the like. Also, the second RAM 322 may store a timestamp or counter used for data encryption.

For example, the second ROM 323 may be an OTP memory. According to some implementations, the second ROM 323 may store the shared key SK required for the second cryptographic circuit 324 to generate a reply authentication code or decoding code.

However, according to some implementations, the shared key SK may be stored in another storage space within the second security processor 122B. Also, the second security processor 122B may communicate with at least one IP included in the second die 102B through the second mailbox 325.

According to some implementations, the second security processor 122B may verify whether the security message SM has been tampered with, using the prestored shared key SK. For example, the second cryptographic circuit 324 may generate a decoding code from the components of the security message SM, excluding the authentication code AC, using the shared key SK. Additionally, the second cryptographic circuit 324 may generate a decoding code from the command CMD, included in the security message SM, using the shared key SK. Moreover, the second cryptographic circuit 324 may generate a decoding code from at least a portion of the security message SM through a cryptographic algorithm, such as HMAC-SHA256 or AES-GMAC, using the shared key SK. Accordingly, the second cryptographic circuit 324 may store a cryptographic algorithm, such as HMAC-SHA256 or AES-GMAC, in the form of software code programmed internally or in the form of hardcoded hardware code.

The second execution circuit 327 may determine whether the decoding code is the same as the authentication code AC included in the security message SM. For example, when the decoding code is the same as the authentication code AC included in the security message SM, the second execution circuit 327 may determine that the security message SM has not been tampered with. When the decoding code is different from the authentication code AC included in the security message SM, the second execution circuit 327 may determine that the security message SM has been tampered with.

Furthermore, when it is determined that the security message SM has not been tampered with, the second security processor 122B may perform an operation based on the command CMD included in the security message SM. For example, when it is determined that the security message SM has not been tampered with, the second security processor 122B may perform a security-required operation on at least one IP block included in the second die 102B based on the command CMD.

The second security processor 122B may generate a reply security message to be transmitted to the first security processor 121B using the second generator 326. For example, the second security processor 122B may generate a reply security message, including a reply authentication code generated through the second cryptographic circuit 324, using the second generator 326.

Referring to the foregoing configuration, the first security processor 121B may transmit a security message SM, including an authentication code generated using the prestored shared key SK, to the second security processor 122B. Also, the second security processor 122B may determine whether the security message SM has been tampered with, using the authentication code included in the security message SM and the prestored shared key SK. For example, the first die 101B and the second die 102B may exchange a security message SM including an authentication code generated based on the shared key SK commonly stored in the security processors 121B and 122B of each die.

The semiconductor system 100B may prevent an external attack (for example, hacking) on the communication channel (for example, the first channel CH1) between the dies 101B and 102B. For example, the semiconductor system 100B may improve the security of communication between the dies 101B and 102B.

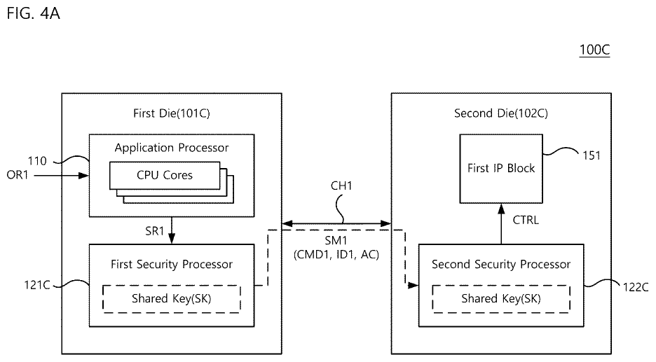

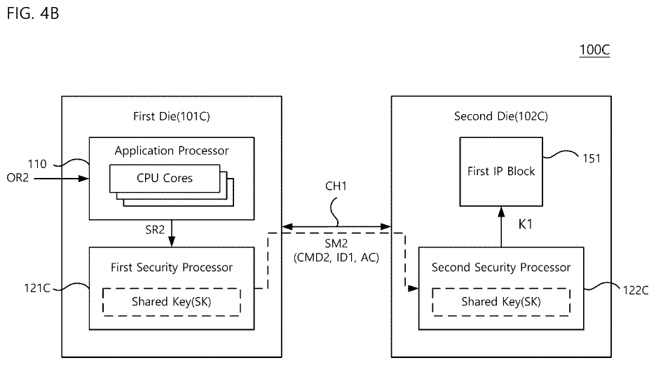

FIG. 4A is a diagram illustrating an example configuration, in which a second die sets the security level for a first IP block in response to a first request according to some implementations. FIG. 4B is a diagram illustrating an example configuration, in which a second die generates a security key for a first IP block in response to a second request according to some implementations.

In FIGS. 4A and 4B, a semiconductor system 100C may include a first die 101C and a second die 102C. The second die 102C may include a first IP block 151 and a second security processor 122C.

The semiconductor system 100C illustrated in FIGS. 4A and 4B may be understood as an example of the semiconductor system 100 illustrated in FIG. 1. For example, the second die 102C may be understood to have a configuration in which the first IP block 151 is further included in the second die 102 illustrated in FIG. 1. Accordingly, the same or substantially the same components are represented by the same reference numerals, and redundant descriptions will be omitted to avoid repetition.

The first IP block 151 may be understood as either a single circuit configured to perform a specified function or a set of circuits, each configured to perform a specified function.

In FIG. 4A, the application processor 110 may transmit a first security request SR1 to the first security processor 121C in response to a first operation request OR1. For example, the application processor 110 may transmit a first security request SR1 to the first security processor 121C in response to receiving a first operation request OR1 for a first operation of setting a security level of the first IP block 151.

The first security processor 121C may generate an authentication code AC using the prestored shared key SK in response to the first security request SR1 transmitted from the application processor 110. The first security processor 121C may generate a first command CMD1 corresponding to the first operation in response to the first security request SR1. Also, the first security processor 121C may generate first specific information ID1 corresponding to the first IP block 151.

The first security processor 121C may generate an authentication code AC from the first command CMD1 and the first specific information ID1 using the shared key SK. For example, the first security processor 121C may generate an authentication code AC from the first command CMD1 and the first specific information ID1 using a cryptographic algorithm, such as HMAC-SHA256 or AES-GMAC, and the shared key SK.

The first security processor 121C may transmit a first security message SM1, including the first command CMD1, the first specific information ID1, and the authentication code AC, to the second security processor 122C. The first security processor 121C may transmit the first security message SM1 to the second security processor 122C through the first channel CH1.

According to some implementations, the second security processor 122C may verify whether the first security message SM1 has been tampered with, using the prestored shared key SK. The shared key SK, stored in the second security processor 122C, may be referred to as being substantially the same as the shared key SK stored in the first security processor 121C. For example, the second security processor 122C may generate a decoding code from the first command CMD1 and the first specific information ID1, included in the first security message SM1, using the shared key SK. The second security processor 122C may generate a decoding code from the first command CMD1 and the first specific information ID1 using a cryptographic algorithm, such as HMAC-SHA256 or AES-GMAC, and the shared key SK. Also, the second security processor 122C may determine whether the decoding code is the same as the authentication code AC included in the first security message SM1. For example, when the decoding code is the same as the authentication code AC included in the first security message SM1, the second security processor 122C may determine that the first security message SM1 has not been tampered with. When the decoding code is different from the authentication code AC included in the first security message SM1, the second security processor 122C may determine that the first security message SM1 has been tampered with.

Furthermore, when it is determined that the first security message SM1 has not been tampered with, the second security processor 122C may perform a first operation based on the first command CMD1 included in the first security message SM1. For example, when it is determined that the first security message SM1 has not been tampered with, the second security processor 122C may set the security level of the first IP block 151 to a first security level based on the first command CMD1. When it is determined that the first security message SM1 has not been tampered with, the second security processor 122C may transmit a control signal CTRL to the first IP block 151 such that the security level of the first IP block 151 is set to the first security level. Additionally, when it is determined that the first security message SM1 has not been tampered with, the second security processor 122C may set (or change) the security level of the first IP block 151 based on the first command CMD1 included in the first security message SM1.

For example, when it is determined that the message transmitted from the first die 101C has not been tampered with, the second die 102C may perform an operation of changing the security level of the first IP block 151 based on the command included in the transmitted message.

In addition, the second security processor 122C may transmit result data, including information indicating that the security level of the first IP block 151 is the first security level, to the application processor 110. For example, the second security processor 122C may transmit result data, including information indicating that the security level of the first IP block 151 has been set to the first security level, to the application processor 110 through the first channel CH1.

In FIG. 4B, the application processor 110 may transmit a second security request SR2 to the first security processor 121C in response to a second operation request OR2. For example, the application processor 110 may transmit a second security request SR2 to the first security processor 121C in response to receiving a second operation request OR2 for a second operation of generating a security key K1 for the first IP block 151.

Also, the first security processor 121C may generate an authentication code AC using a prestored shared key SK in response to the second security request SR2 transmitted from the application processor 110. For example, the first security processor 121C may generate a second command CMD2 corresponding to the second operation in response to the second security request SR2. Also, the first security processor 121C may generate first specific information ID1 corresponding to the first IP block 151.

In addition, the first security processor 121C may generate an authentication code AC from the second command CMD2 and the first specific information ID1 using the shared key SK. For example, the first security processor 121C may generate an authentication code AC from the second command CMD2 and the first specific information ID1 using a cryptographic algorithm, such as HMAC-SHA256 or AES-GMAC, and the shared key SK. Also, the first security processor 121C may transmit a second security message SM2, including the second command CMD2, the first specific information ID1, and the authentication code AC, to the second security processor 122C.

The first security processor 121C may transmit the second security message SM2 to the second security processor 122C through the first channel CH1.

According to some implementations, the second security processor 122C may verify whether the second security message SM2 has been tampered with, using the prestored shared key SK. The shared key SK, stored in the second security processor 122C, may be referred to as being substantially the same as the shared key SK stored in the first security processor 121C. For example, the second security processor 122C may generate a decoding code from the second command CMD2 and the first specific information ID1, included in the second security message SM2, using the shared key SK. Additionally, the second security processor 122C may generate a decoding code from the second command CMD2 and the first specific information ID1 using a cryptographic algorithm, such as HMAC-SHA256 or AES-GMAC, and the shared key SK.

Also, the second security processor 122C may determine whether the decoding code is the same as the authentication code AC included in the second security message SM2. For example, when the decoding code is the same as the authentication code AC included in the second security message SM2, the second security processor 122C may determine that the second security message SM2 has not been tampered with. When the decoding code is different from the authentication code AC included in the second security message SM2, the second security processor 122C may determine that the second security message SM2 has been tampered with.

Furthermore, when it is determined that the second security message SM2 has not been tampered with, the second security processor 122C may perform a second operation based on the second command CMD2 included in the second security message SM2. For example, when it is determined that the second security message SM2 has not been tampered with, the second security processor 122C may generate a security key K1 for the first IP block 151 based on the second command CMD2. Furthermore, the second security processor 122C may transmit the generated security key K1 to the first IP block 151. When it is determined that the second security message SM2 has not been tampered with, the second security processor 122C may generate (or change) the security key K1 for the first IP block 151 based on the second command CMD2 included in the second security message SM2.

When it is determined that the message transmitted from the first die 101C has not been tampered with, the second die 102C may perform an operation of generating the security key K1 for the first IP block 151 based on the second command CMD2 included in the transmitted message.

Referring to the foregoing configuration, the second security processor 122C may determine whether a message transmitted from the first die 101C has been tampered with, using the shared key SK commonly stored with the first security processor 121C. Furthermore, the second security processor 122C may perform a security-required operation based on a command included in a transmitted message when it is determined that a message transmitted from the first die 101C has not been tampered with. As a result, the semiconductor system 100C a may significantly reduce the weakening of security caused by an external attack on the communication channel between the dies 101C and 102C. For example, the semiconductor system 100C may improve the security of communication between the dies 101C and 102C.

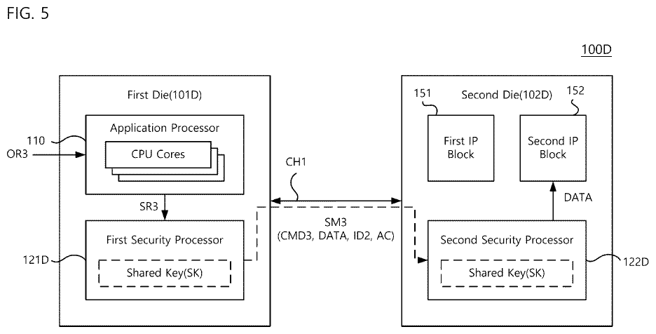

FIG. 5 is a diagram illustrating an example configuration, in which data is transmitted to a second IP block of a second die in response to a third request according to some implementations. In FIG. 5, a semiconductor system 100D may include a first die 101D and a second die 102D. The second die 102D may include a first IP block 151, a second IP block 152, and a second security processor 122D.

The semiconductor system 100D illustrated in FIG. 5 may be understood as an example of the semiconductor system 100 illustrated in FIG. 1. For example, the second die 102D may be understood to have a configuration in which the first IP block 151 and the second IP block 152 are further included in the second die 102 illustrated in FIG. 1. Accordingly, the same or substantially the same components are represented by the same reference numerals, and redundant descriptions will be omitted to avoid repetition.

Each of the first IP block 151 and the second IP block 152 may be understood as either a single circuit configured to perform a specified function or a set of circuits, each configured to perform a specified function.

According to some implementations, the application processor 110 may transmit a third security request SR3 to the first security processor 121D in response to a third operation request OR3. For example, the application processor 110 may transmit a third security request SR3 to the first security processor 121D in response to receiving a third operation request OR3 for a third operation of transmitting data DATA to the second IP block 152.

Also, the first security processor 121D may generate an authentication code AC using a stored shared key SK in response to the third security request SR3 transmitted from the application processor 110. For example, the first security processor 121D may generate a third command CMD3 corresponding to the third operation in response to the third security request SR3. Also, the first security processor 121D may generate second specific information ID2 corresponding to the second IP block 152.

Furthermore, the first security processor 121D may generate an authentication code AC from at least a portion of the third command CMD3, the second specific information ID2, and the data DATA using the shared key SK. For example, the first security processor 121D may generate an authentication code AC from the third command CMD3, the second specific information ID2, and the data DATA using a cryptographic algorithm, such as HMAC-SHA256 or AES-GMAC, and the shared key SK.

Also, the first security processor 121D may transmit a third security message SM3, including the third command CMD3, the data DATA, the second specific information ID2, and the authentication code AC, to the second security processor 122D.

The first security processor 121D may transmit the third security message SM3 to the second security processor 122D through the first channel CH1.

According to some implementations, the second security processor 122D may verify whether the third security message SM3 has been tampered with, using a prestored shared key SK. The shared key SK stored in the second security processor 122D may be referred to as being substantially the same as the shared key SK stored in the first security processor 121D. For example, the second security processor 122D may generate a decoding code from at least a portion of the third command CMD3, the data DATA, and the second specific information ID2 in the third security message SM3, using the shared key SK.

The second security processor 122D may generate a decoding code from the third command CMD3, the data DATA, and the second specific information ID2 using a cryptographic algorithm, such as HMAC-SHA256 or AES-GMAC, and the shared key SK. Also, the second security processor 122D may determine whether the decoding code is the same as the authentication code AC included in the third security message SM3. For example, when the decoding code is the same as the authentication code AC included in the third security message SM3, the second security processor 122D may determine that the third security message SM3 has not been tampered with. When the decoding code is different from the authentication code AC included in the third security message SM3, the second security processor 122D may determine that the third security message SM3 has been tampered with.

Furthermore, when it is determined that the third security message SM3 has not been tampered with, the second security processor 122D may perform a third operation based on the third command CMD3 included in the third security message SM3. For example, when it is determined that the third security message SM3 has not been tampered with, the second security processor 122D may transmit the data DATA to the second IP block 152 based on the third command CMD3. When it is determined that the message transmitted from the first die 101D has not been tampered with, the second die 102D may transmit the data included in the transmitted message to at least one IP block based on a command included in the transmitted message.

Referring to the foregoing configuration, the second security processor 122D may determine whether a message transmitted from the first die 101D has been tampered with, using the shared key SK commonly stored with the first security processor 121D. Furthermore, when it is determined that a message transmitted from the first die 101D has not been tampered with, the second security processor 122D may perform a security-required operation based on a command included in a transmitted message. As a result, the semiconductor system 100D may significantly reduce security vulnerability caused by an external attack on the communication channel between the dies 101D and 102D. For example, the semiconductor system 100D may improve the security of communication between the dies 101D and 102D.

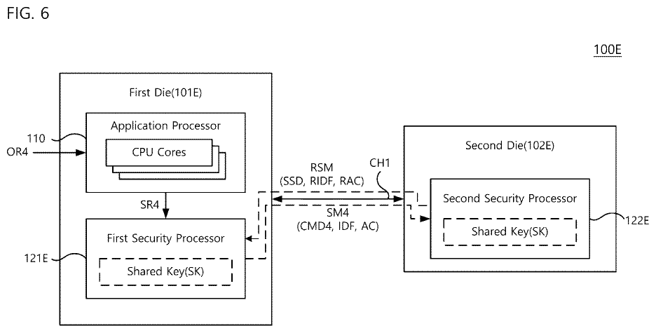

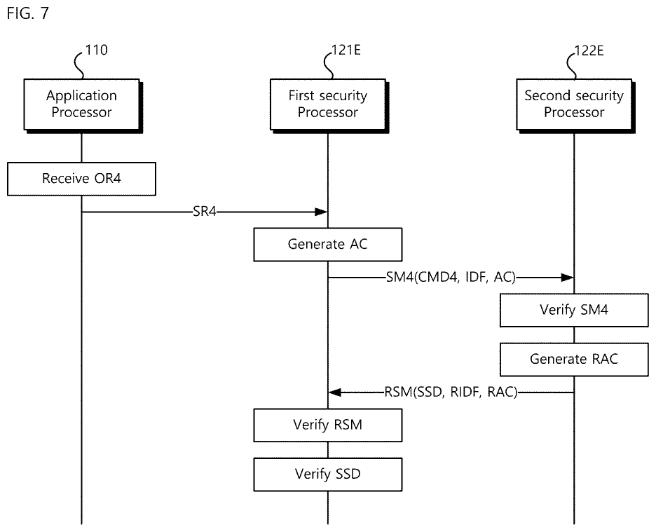

FIG. 6 is a diagram illustrating an example configuration, in which a first security processor verifies the security of a second die in response to a fourth request according to some implementations. FIG. 7 is a diagram illustrating examples of messages and requests exchanged by an application processor, a first security processor, and a second security processor in response to a fourth request according to some implementations.

In FIG. 6, a semiconductor system 100E may include a first die 101E and a second die 102E. The semiconductor system 100E illustrated in FIG. 6 may be understood as an example of the semiconductor system 100 illustrated in FIG. 1. Accordingly, the same or substantially the same components are represented by the same reference numerals, and redundant descriptions will be omitted to avoid repetition.

In FIGS. 6 and 7, an application processor 110 may receive a fourth operation request OR4. For example, the application processor 110 may receive a fourth operation request OR4 for a fourth operation of verifying (or authenticating) the second die 102E.

In addition, the application processor 110 may transmit a fourth security request SR4 to a first security processor 121E in response to a fourth operation request OR4. For example, the application processor 110 may transmit a fourth security request SR4 to the first security processor 121E in response to receiving a fourth operation request OR4 for a fourth operation of verifying or authenticating the second die 102E. Accordingly, the fourth operation request OR4 may be referred to as, for example, a verification request or an authentication request.

The first security processor 121E may generate an authentication code AC using a prestored shared key SK in response to the fourth security request SR4 transmitted from the application processor 110. For example, the first security processor 121E may generate a fourth command CMD4 corresponding to the fourth operation in response to the fourth security request SR4. Also, the first security processor 121E may generate an identifier IDF.

The identifier IDF may be understood as a nonce, a randomly generated cryptographic token. For example, the identifier IDF may be understood as a timestamp proving a state of a die at a specific time point. However, the type and configuration of the identifier are not limited to the above examples.

In addition, the first security processor 121E may generate an authentication code AC from at least a portion of the fourth command CMD4 and the identifier IDF using a shared key SK. For example, the first security processor 121E may generate an authentication code AC from the fourth command CMD4 and the identifier IDF using a cryptographic algorithm, such as HMAC-SHA256 or AES-GMAC, and the shared key SK.

Also, the first security processor 121E may transmit a fourth security message SM4, including the fourth command CMD4, the identifier IDF, and the authentication code AC, to the second security processor 122E. The first security processor 121E may transmit the fourth security message SM4 to the second security processor 122E through the first channel CH1.

According to some implementations, the second security processor 122E may verify whether the fourth security message SM4 has been tampered with, using the prestored shared key SK. The shared key SK stored in the second security processor 122E may be referred to as being substantially the same as the shared key SK stored as in the first security processor 121E. For example, the second security processor 122E may generate a decoding code from at least a portion of the fourth command CMD4 and the identifier IDF included in the fourth security message SM4, using the shared key SK. The second security processor 122E may generate a decoding code from the fourth command CMD4 and the identifier IDF using a cryptographic algorithm, such as HMAC-SHA256 or AES-GMAC, and the shared key SK.

Also, the second security processor 122E may determine whether the decoding code is the same as an authentication code AC included in the fourth security message SM4. For example, when the decoding code is the same as the authentication code AC included in the fourth security message SM4, the second security processor 122E may determine that the fourth security message SM4 has not been tampered with. When the decoding code is different from the authentication code AC included in the fourth security message SM4, the second security processor 122E may determine that the fourth security message SM4 has been tampered with.

Furthermore, when the second security processor 122E determines that the fourth security message SM4 has not been tampered with, the second security processor 122E may generate a response authentication code RAC. For example, when the second security processor 122E determines that the fourth security message SM4 has not been tampered with, the second security processor 122E may identify security status data SSD of the second die 102E.

The security status data SSD may be understood as data related to the information of bits indicating whether the security functions of the second die 102E are activated. For example, the security status data SSD may include data related to a bit having a value of “1” when a secure JTAG function of the second die 102E is activated. The security status data SSD may include data related to a bit having a value of “1” when the secure boot function of the second die 102E is activated.

When the second security processor 122E determines that the fourth security message SM4 has not been tampered with, the second security processor 122E may generate a response identifier RIDF. For example, when the identifier IDF included in the fourth security message SM4 is a nonce, the second security processor 122E may generate the same nonce as an identifier IDF, as the response identifier RIDF. When the identifier IDF included in the fourth security message SM4 is a timestamp, the second security processor 122E may add a predetermined time value to the transmitted timestamp to generate a result of the addition as the response identifier RIDF.

Furthermore, when the second security processor 122E determines that the fourth security message SM4 has not been tampered with, the second security processor 122E may generate a response authentication code RAC from at least a portion of the security status data SSD and the response identifier RIDF using the shared key SK. For example, the second security processor 122E may generate a response authentication code RAC from the security status data SSD and the response identifier RIDF using a cryptographic algorithm, such as HMAC-SHA256 or AES-GMAC, and the shared key SK. Also, the second security processor 122E may transmit a response security message RSM, including the security status data SSD, the response identifier RIDF, and the response authentication code RAC, to the first security processor 121E.

The second security processor 122E may transmit the response security message RSM to the first security processor 121E through a first channel CH1.

According to some implementations, the first security processor 121E may verify whether the response security message RSM has been tampered with, using the prestored shared key SK. For example, the first security processor 121E may generate a response decoding code from at least a portion of the security status data SSD and the response identifier RIDF included in the response security message RSM, using the shared key SK.

The first security processor 121E may generate a response decoding code from the security status data SSD and the response identifier RIDF using a cryptographic algorithm, such as HMAC-SHA256 or AES-GMAC, and the shared key SK. Also, the first security processor 121E may determine whether the response decoding code is the same as the response authentication code RAC included in the response security message RSM. For example, when the response decoding code is the same as the response authentication code RAC included in the response security message RSM, the first security processor 121E may determine that the response security message RSM has not been tampered with. When the response decoding code is different from the response authentication code RAC included in the response security message RSM, the first security processor 121E may determine that the response security message RSM has been tampered with.

Furthermore, the first security processor 121E may verify whether the second die 102E has been tampered with, based on at least a portion of the security status data SSD and the response identifier RIDF.

According to some implementations, when the identifier IDF and the response identifier RIDF are nonces, the first security processor 121E may determine that the security status data SSD has not been tampered with, in response to the response identifier RIDF being the same as the identifier IDF.

According to some implementations, when the identifier IDF and the response identifier RIDF are timestamps, the first security processor 121E may determine that the security status data SSD has not been tampered with, in response to the response identifier RIDF having a value obtained by adding a predetermined time interval to the identifier IDF.

Furthermore, when the first security processor 121E determines that the security status data SSD has not been tampered with, the first security processor 121E may determine that the second die 102E has security, based on the security status data SSD. For example, when the first security processor 121E determines that the security status data SSD has not been tampered with, it may determine whether at least a portion of the security functions of the second die 102E are activated from the security status data SSD. As a result, the first security processor 121E may authenticate that the second die 102E has not been replaced, forged, or changed in security state due to external factors.

Referring to the above-described configuration, the first security processor 121E according to an some implementations may exchange security messages SM4 and RSM using the shared key SK, commonly stored by the first security processor 121E and the second security processor 122E. Furthermore, the first security processor 121E may verify the security of the second die 102E using the response security message RSM. As a result, the semiconductor system 100E may prevent the weakening of security caused by the replacement or forgery of at least a portion of the dies 101E and 102E due to external factors. For example, the semiconductor system 100E may improve the security of communication between the dies 101E and 102E.

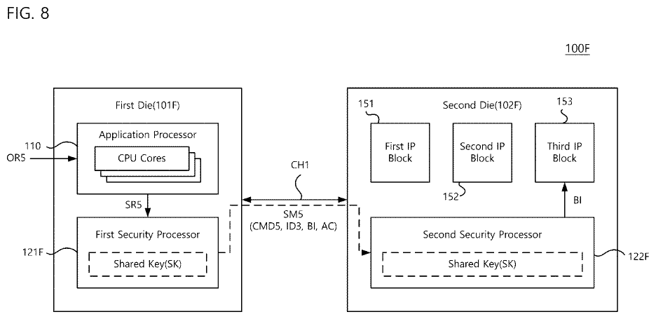

FIG. 8 is a diagram illustrating an example configuration to operate a third IP block of a second die in response to a fifth request according to some implementations. In FIG. 8, a semiconductor system 100F may include a first die 101F and a second die 102F. The second die 102F may include a first IP block 151, a second IP block 152, a third IP block 153, and a second security processor 122F.

The semiconductor system 100F illustrated in FIG. 8 may be understood as an example of the semiconductor system 100 illustrated in FIG. 1. For example, the second die 102F may be understood to have a configuration in which the first IP block 151, the second IP block 152, and the third IP block 153 are further included in the second die 102 illustrated in FIG. 1. Accordingly, the same or substantially the same components are represented by the same reference numerals, and redundant descriptions will be omitted to avoid repetition.

Each of the first IP block 151, the second IP block 152, and the third IP block 153 may be understood as either a single circuit configured to perform a specified function or a set of circuits, each configured to perform a specified function.

The application processor 110 may transmit a fifth security request SR5 to the first security processor 121F in response to a fifth operation request OR5. For example, the application processor 110 may transmit a fifth security request SR5 to the first security processor 121F in response to receiving a fifth operation request OR5 for a fifth operation of booting the third IP block 153. Accordingly, the fifth operation request OR5 may also be referred to as, for example, a power-on request.

Also, the first security processor 121F may generate an authentication code AC using the prestored shared key SK in response to the fifth security request SR5 transmitted from the application processor 110. For example, the first security processor 121F may generate a fifth command CMD5 corresponding to the fifth operation in response to the fifth security request SR5. Also, the first security processor 121F may generate third specific information ID3 corresponding to the third IP block 153.

Additionally, the first security processor 121F may load a boot image BI for booting the third IP block 153. For example, the first security processor 121F may load a prestored boot image BI from a memory device, or a universal flash storage (UFS), in response to the fifth security request SR5.

The memory device may be implemented and disposed separately from the first die 101F and connected to the first security processor 121F. For example, the first security processor 121F may load a prestored boot image BI from a storage space within the first die 101F or the first security processor 121F.

Furthermore, the first security processor 121F may generate an authentication code AC from at least a portion of the fifth command CMD5, the third specific information ID3, and the boot image BI using the shared key SK. For example, the first security processor 121F may generate an authentication code AC from the fifth command CMD5, the third specific information ID3, and the boot image BI using a cryptographic algorithm, such as HMAC-SHA256 or AES-GMAC, and the shared key SK.

According to some implementations, the first security processor 121F may verify an electronic signature, included in the boot image BI, using a prestored public key and a first cryptographic circuit 314. For example, the first security processor 121F may verify an electronic signature, included in the boot image BI, using an elliptic curve digital signature algorithm (ECDSA), a digital signature algorithm (DSA), or a Rivest-Shamir-Adleman algorithm (RSA), the public key, and the first cryptographic circuit 314.

The first security processor 121F may verify an electronic signature, included in the boot image BI, using a post-quantum cryptography (PQC) algorithm, such as a module lattice digital signature algorithm (ML-DSA) or a stateless hash-based digital signature algorithm (SLH-DSA), the public key, and the first cryptographic circuit 314. Furthermore, the first security processor 121F may generate a fifth security message SM5 in response to successful verification of the electronic signature of the boot image BI.

The first security processor 121F may transmit a fifth security message SM5, including the fifth command CMD5, the third specific information ID3, the boot image BI, and the authentication code AC, to the second security processor 122F.

According to some implementations, the first security processor 121F may transmit the fifth security message SM5 to the second security processor 122F through the first channel CH1.

According to some implementations, the second security processor 122F may verify whether the fifth security message SM5 has been tampered with, using the prestored shared key SK.

The shared key SK stored in the second security processor 122F may be referred to as being substantially the same as the shared key SK stored in the first security processor 121F. For example, the second security processor 122F may generate a decoding code from at least a portion of the fifth command CMD5, the third specific information ID3, and the boot image BI, using the shared key SK.

For another example, the second security processor 122F may generate a decoding code from the fifth command CMD5, the third specific information ID3, and the boot image BI using a cryptographic algorithm, such as HMAC-SHA256 or AES-GMAC, and the shared key SK. Also, the second security processor 122F may determine whether the decoding code is the same as the authentication code AC included in the fifth security message SM5. For example, when the decoding code is the same as the authentication code AC included in the fifth security message SM5, the second security processor 122F may determine that the fifth security message SM5 has not been tampered with. When the decoding code is different from the authentication code AC included in the fifth security message SM5, the second security processor 122F may determine that the fifth security message SM5 has been tampered with.

Furthermore, when the second security processor 122F determines that the fifth security message SM5 has not been tampered with, the second security processor 122F may perform a fifth operation based on the fifth command CMD5 included in the fifth security message SM5. For example, when it is determined that the fifth security message SM5 has not been tampered with, the second security processor 122F (or the second cryptographic circuit 324) may verify the electronic signature of the boot image BI, transmitted through the fifth security message SM5, using the public key.

The second security processor 122F may verify the electronic signature, included in the boot image BI, using the ECDSA, DSA, or RSA algorithm and the public key. Furthermore, the second security processor 122F may transmit the boot image BI to the third IP block 153 based on the fifth command CMD5. Accordingly, the second security processor 122F may operate the third IP block 153. For example, when it is determined that the message transmitted from the first die 101F has not been tampered with, the second die 102F may operate at least one IP block based on the command included in the transmitted message.

Referring to the foregoing configuration, the second security processor 122F according to some implementations may determine whether a message transmitted from the first die 101F has been tampered with, using the shared key SK commonly stored with the first security processor 121F.

Furthermore, when it is determined that a message transmitted from the first die 101F has not been tampered with, the second security processor 122F may perform a security-required operation based on a command included in a transmitted message. As a result, the semiconductor system 100F may significantly reduce the weakening of security caused by an external attack on the communication channel between the dies 101F and 102F. For example, the semiconductor system 100F may improve the security of communication between the dies 101F and 102F.

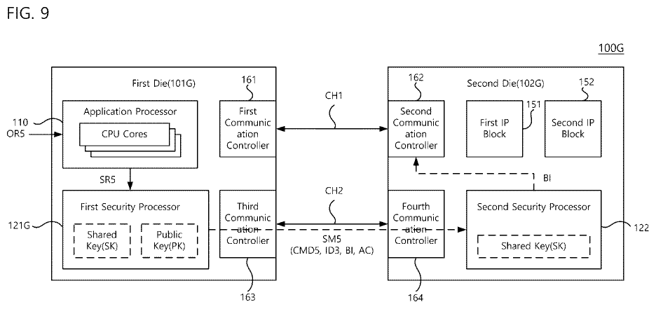

FIG. 9 is a diagram illustrating an example configuration to operate a second communication controller of a second die in response to a fifth request according to some implementations. In FIG. 9, a semiconductor system 100G may include a first die 101G and a second die 102G.

The first die 101G may include an application processor 110, a first security processor 121G, a first communication controller 161, and a third communication controller 163. The second die 102G may include a first IP block 151, a second IP block 152, a second communication controller 162, a fourth communication controller 164, and a second security processor 122G.

The semiconductor system 100G illustrated in FIG. 9 may be understood as an example of the semiconductor system 100 illustrated in FIG. 1. For example, the first die 101G may be understood to have a configuration in which the first communication controller 161 and the third communication controller 163 are further included in the first die 101 illustrated in FIG. 1. Also, the second die 102G may be understood to have a configuration in which the first IP block 151, the second IP block 152, the second communication controller 162, and the fourth communication controller 164 are further included in the second die 102 illustrated in FIG. 1. Accordingly, the same or substantially the same components are represented by the same reference numerals, and redundant descriptions will be omitted to avoid repetition.

Each of the first IP block 151 and the second IP block 152 may be understood as either a single circuit configured to perform a specified function or a set of circuits, each configured to perform a specified function.

According to some implementations, the first die 101G may include a first communication controller 161 connected to the first channel CH1, and the second die 102G may include a second communication controller 162 connected to the first channel CH1. Accordingly, the first communication controller 161 and the second communication controller 162 may be referred to as interface circuits for communication through the first channel CH1. For example, the first channel CH1 may be understood as a communication channel through a high-speed serial interface, such as Peripheral Component Interconnect Express (PCIe) or Universal Chiplet Interconnect Express (UCIe).

The first die 101G may include a third communication controller 163 connected to the second channel CH2, and the second die 102G may include a fourth communication controller 164 connected to the second channel CH2. Accordingly, the third communication controller 163 and the fourth communication controller 164 may be referred to as interface circuits for communication through the second channel CH2. For example, the second channel CH2 may be understood as a communication channel through a communication interface, such as serial peripheral interface (SPI), inter-integrated circuit (I2C), or I3C. The second channel CH2 may be referred to as having a relatively lower communication speed compared to the first channel CH1.

According to some implementations, the application processor 110 may transmit a fifth security request SR5 to the first security processor 121G in response to a fifth operation request OR5. For example, the application processor 110 may transmit a fifth security request SR5 to the first security processor 121G in response to receiving a fifth operation request OR5 for a fifth operation of booting the second communication controller 162. Accordingly, the fifth operation request OR5 may also be referred to a driving request.

The second communication controller 162 may be understood as an example of the third IP block 153 of FIG. 8. Accordingly, the fifth operation request OR5 for driving the third IP block 153 of FIG. 8 may be understood as being the same as the fifth operation request OR5 for driving the second communication controller 162 of FIG. 9.

The first security processor 121G may generate an authentication code AC using a prestored shared key SK in response to the fifth security request SR5 transmitted from the application processor 110. For example, the first security processor 121G may generate a fifth command CMD5 corresponding to the fifth operation in response to the fifth security request SR5. Also, the first security processor 121G may generate third specific information ID3 corresponding to the second communication controller 162.

Also, the first security processor 121G may load a boot image BI for booting the second communication controller 162. For example, the first security processor 121G may load a prestored boot image BI from a memory device, or a universal flash storage (UFS), in response to the fifth security request SR5.

The memory device may be implemented and disposed separately from the first die 101G and connected to the first security processor 121G. For example, the first security processor 121G may load the prestored boot image BI from a storage space within the first die 101G or the first security processor 121G.

Furthermore, the first security processor 121G may generate an authentication code AC from at least a portion of the fifth command CMD5, the third specific information ID3, and the boot image BI using the shared key SK. For example, the first security processor 121G may generate an authentication code AC from the fifth command CMD5, the third specific information ID3, and the boot image BI using a cryptographic algorithm, such as HMAC-SHA256 or AES-GMAC, and the shared key SK.

Also, the first security processor 121G may transmit a fifth security message SM5, including the fifth command CMD5, the third specific information ID3, the boot image BI, and the authentication code AC, to the second security processor 122G.

According to some implementations, the first security processor 121G may transmit the fifth security message SM5 to the second security processor 122G through the second channel CH2.

The third communication controller 163 and the fourth communication controller 164 may be turned on when the first die 101G and the second die 102G are booted (or driven). For example, the second channel CH2 may be activated as the first die 101G and the second die 102G are booted.

According to some implementations, the second security processor 122G may verify whether the fifth security message SM5 has been tampered with, using a prestored shared key SK. The shared key SK stored in the second security processor 122G may be referred to as being substantially the same as the shared key SK stored in the first security processor 121G. For example, the second security processor 122G may generate a decoding code from at least a portion of the fifth command CMD5, the third specific information ID3, and the boot image BI, using the shared key SK.

The second security processor 122G may generate a decoding code from the fifth command CMD5, the third specific information ID3, and the boot image BI using a cryptographic algorithm, such as HMAC-SHA256 or AES-GMAC, and the shared key SK.

Also, the second security processor 122G may determine whether the decoding code is the same as the authentication code AC included in the fifth security message SM5. For example, when the decoding code is the same as the authentication code AC included in the fifth security message SM5, the second security processor 122G may determine that the fifth security message SM5 has not been tampered with. When the decoding code is different from the authentication code AC included in the fifth security message SM5, the second security processor 122G may determine that the fifth security message SM5 has been tampered with.

Furthermore, when it is determined that the fifth security message SM5 has not been tampered with, the second security processor 122G may perform a fifth operation based on the fifth command CMD5 included in the fifth security message SM5. For example, when it is determined that the fifth security message SM5 has not been tampered with, the second security processor 122G may transmit the boot image BI to the second communication controller 162, based on the fifth command CMD5. As a result, the second security processor 122G may operate the second communication controller 162. In addition, the second security processor 122G may activate the first channel CH1.

Furthermore, the first die 101G and the second die 102G may exchange data or messages through the first channel CH1 while the first channel CH1 is activated. For example, when it is determined that the message transmitted from the first die 101G has not been tampered with, the second die 102G may activate the communication channel based on the command included in the transmitted message.

Referring to the above-described configuration, the second security processor 122G according to some implementations may determine whether a message transmitted from the first die 101G has been tampered with, using the shared key SK commonly stored with the first security processor 121G.

Furthermore, when it is determined that a message transmitted from the first die 101G has not been tampered with, the second security processor 122G may perform a security-required operation based on a command included in a transmitted message. As a result, the semiconductor system 100G may significantly reduce the weakening of security caused by an external attack on the communication channel between the dies 101G and 102G. For example, the semiconductor system 100G may improve the security of communication between the dies 101G and 102G.

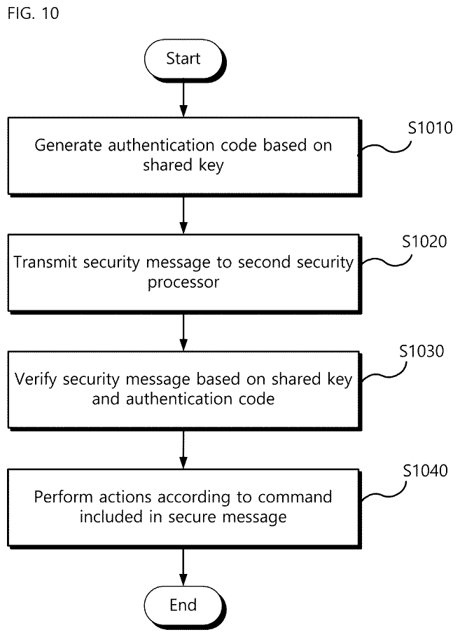

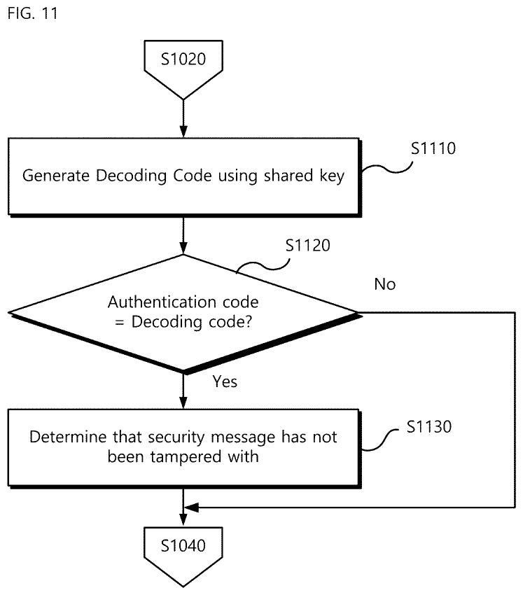

FIG. 10 is a flowchart illustrating an example of a method for verifying security between interconnected dies according to some implementations. FIG. 11 is a flowchart illustrating an example of a method by which a second security processor verifies whether a security message transmitted from a first die has been tampered with according to some implementations.

In FIGS. 10 and 11, a semiconductor system, such as any of the semiconductor systems 100, 100A, 100B, 100C, 100D, and 100E may be controlled to perform communication through a security message SM including an authentication code AC generated using a shared key SK commonly stored by a plurality of dies 101 and 102. For example, the first die 101 and the second die 102 communicating with each other, among a plurality of dies included in the semiconductor system 100, may store the same shared key SK.

Also, the semiconductor system 100 may include die groups, respectively storing different shared keys. The semiconductor system may include, for example, a first die group including at least two or more dies storing the same shared key. Also, the semiconductor system 100 may include, for example, a second die group including at least two or more dies storing a shared key, different from that stored in the first die group.

Furthermore, each of the plurality of dies included in the semiconductor system may store a plurality of different shared keys. For example, the first die 101 may store a plurality of shared keys, commonly stored with each die, to communicate with each of the other dies. For example, die groups including dies communicating with each other, among the plurality of dies included in the semiconductor system, may store the same shared key.

In operation S1010, the first security processor 121 may generate an authentication code AC using a stored shared key SK in response to a security request SR transmitted from the application processor 110. The security request SR may be referred to as a request that the application processor 110 outputs to the first security processor 121 in response to an operation request OR for an operation requiring security of the second die 102. For example, the first security processor 121 may generate an authentication code AC using a cryptographic algorithm, such as HMAC-SHA256 or AES-GMAC, and a shared key SK.

In operation S1020, the first security processor 121 may transmit a security message SM, including a command CMD corresponding to the operation requested through the operation request OR and the authentication code AC, to the second security processor 122. For example, the security message SM may further include at least a portion of data DATA and an identifier IDF, but example embodiments are not limited thereto. The first security processor 121 may transmit the security message SM, including the command CMD and the authentication code AC, to the second security processor 122 through a first channel CH1.

In operation S1030, the second security processor 122 may verify whether the security message SM has been tampered with, using the stored shared key SK and the authentication code AC. The shared key SK stored in the second security processor 122 may be referred to as being substantially the same as the shared key SK stored in the first security processor 121.

In FIG. 11 together, in operation S1110, the second security processor 122 may generate a decoding code using the shared key SK. For example, the second security processor 122 may generate a decoding code from components of the security message SM, excluding the authentication code AC, using the shared key SK. The second security processor 122 may generate a decoding code from the command CMD using a cryptographic algorithm, such as HMAC-SHA256 or AES-GMAC, and the shared key SK.

In operation S1120, the second security processor 122 may determine whether the decoding code is the same as the authentication code AC included in the security message SM.

In operation S1130, when the decoding code is the same as the authentication code AC included in the security message SM, the second security processor 122 may determine that the security message SM has not been tampered with. For example, when the decoding code is different from the authentication code AC included in the security message SM, the second security processor 122 may determine that the security message SM has been tampered with.

In operation S1040, when it is determined that the security message SM has not been tampered with, the second security processor 122 may perform an operation based on the command CMD included in the security message SM. For example, when it is determined determines that the security message SM has not been tampered with, the second security processor 122 may change security setting of at least one block included in the second die 102 based on the command CMD. When it is determined that the security message SM has not been tampered with, the second security processor 122 may generate a security key for at least one block included in the second die 102 based on the command CMD.

For another example, when it is determined that the security message SM has not been tampered with, the second security processor 122 may perform an operation requested through an operation request OR for at least one IP block included in the second die 102 based on the command CMD.

Referring to the foregoing configuration, the first security processor 121 may transmit a security message SM, including an authentication code AC generated using a stored shared key SK, to the second security processor 122. Also, the second security processor 122 may determine whether the security message SM has been tampered with, using the authentication code AC included in the security message SM and the prestored shared key SK. Furthermore, when it is determined that a message transmitted from the first die 101 has not been tampered with, the second security processor 122 may perform a security-required operation based on a command included in a transmitted message. As a result, the semiconductor system 100 may prevent an external attack (for example, hacking) on a communication channel (for example, the first channel CH1) between the dies 101 and 102. For example, the semiconductor system 100 may improve the security of communication between the dies 101 and 102.

Also, referring to the foregoing configuration, the semiconductor system 100 may ensure the security of communication between the dies 101 and 102 using an authentication code SK without encrypting data exchanged between the dies 101 and 102. For example, the semiconductor system 100 may perform communication through the security message SM, including the authentication code AC, to significantly reduce the configuration (or circuit) required to encrypt all pieces of data (or messages) exchanged between the dies 101 and 102. As a result, the semiconductor system 100 may operate with relatively less power compared to a case in which all pieces of data (or messages) exchanged between the dies 101 and 102 are encrypted.

In addition, the semiconductor system 100 may be implemented in a relatively smaller area compared to a case in which all pieces of data (or messages) exchanged between the dies 101 and 102 are encrypted.

Furthermore, the semiconductor system 100 may perform communication through the security message SM, including the authentication code AC, to significantly reduce a latency required to encrypt all pieces of data (or messages) exchanged between the dies 101 and 102. As a result, the semiconductor system 100 may have relatively lower latency compared to in a case in which all pieces of data (or messages) exchanged between the dies 101 and 102 are encrypted.

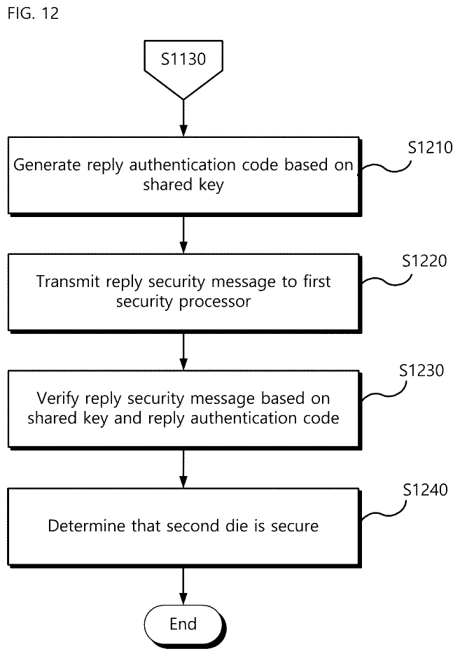

FIG. 12 is a flowchart illustrating an example of a method by which a first die verifies the security of a second die according to some implementations. In FIGS. 10 to 12, the second security processor 122 may transmit a reply security message RSM, including data on a security status of the second die 102, to the first security processor 121 when it is determined that the security message SM has not been tampered with. In addition, the first security processor 121 may verify the security of the second die 102 based on the reply security message RSM.

In operation S1210, the second security processor 122 may generate a reply authentication code RAC when it is determined that the security message SM has not been tampered with. For example, when it is determined that the security message SM has not been tampered with, the second security processor 122 may identify the security status data SSD of the second die 102.

The security status data SSD may be understood as data related to information of bits indicating whether security functions of the second die 102 are activated. For example, the security status data SSD may include data related to a bit having a value of “1” when a secure JTAG function of the second die 102 is activated. The security status data SSD may include data related to a bit having a value of “1” when the secure boot function of the second die 102 is activated.

Also, the second security processor 122 may generate a reply identifier RIDF when it is determined that the security message SM has not been tampered with. For example, when the identifier IDF included in the security message SM is a nonce, the second security processor 122 may generate the same nonce as the reply identifier RIDF. When the identifier IDF included in the security message SM is a timestamp, the second security processor 122 may add a predetermined time value to the transmitted timestamp to generate a reply identifier RIDF. When it is determined that the security message SM has not been tampered with, the second security processor 122 may generate a reply authentication code RAC from at least a portion of the security status data SSD and the reply identifier RIDF using the shared key SK. For example, the second security processor 122 may generate a reply authentication code RAC from the security status data SSD and the reply identifier RIDF using the cryptographic algorithm, such as HMAC-SHA256 or AES-GMAC, and the shared key SK.

In operation S1220, the second security processor 122 may transmit a reply security message RSM, including security status data SSD, reply identifier RIDF, and reply authentication code RAC, to the first security processor 121. For example, the second security processor 122 may transmit a reply security message RSM, including security status data SSD, reply identifier RIDF, and reply authentication code RAC, to the first security processor 121 through the first channel CH1.

In operation S1230, the first security processor 121 may verify whether the reply security message RSM has been tampered with, using the stored shared key SK. For example, the first security processor 121 may generate a reply decoding code from at least a portion of the security status data SSD and the reply identifier RIDF, included in the reply security message RSM, using the shared key SK.

The first security processor 121 may generate a reply decoding code from the security status data SSD and the reply identifier RIDF using the cryptographic algorithm, such as HMAC-SHA256 or AES-GMAC, and the shared key SK. In addition, the first security processor 121 may determine whether the reply decoding code is the same as the reply authentication code RAC included in the reply security message RSM. For example, when the reply decoding code is the same as the reply authentication code RAC included in the reply security message RSM, the first security processor 121 may determine that the reply security message RSM has not been tampered with. When the reply decoding code is different from the reply authentication code RAC included in the reply security message RSM, the first security processor 121 may determine that the reply security message RSM has been tampered with.

In operation S1240, the first security processor 121 may verify whether the second die 102 has security, based on at least a portion of the security status data SSD and the reply identifier RIDF.

According to some implementations, when the identifier IDF and the reply identifier RIDF are nonces, the first security processor 121 may determine that the security status data SSD has not been tampered with, in response to the reply identifier RIDF being the same as the identifier IDF.

According to some implementations, when the identifier IDF and the reply identifier RIDF are timestamps, the first security processor 121 may determine that the security status data SSD has not been tampered with, in response to the reply identifier RIDF having a value obtained by adding a predetermined time interval to the identifier IDF.

Furthermore, when it is determined that the security status data SSD has not been tampered with, the first security processor 121 may determine that the second die 102 has security based on the security status data SSD. For example, when it is determined that the security status data SSD has not been tampered with, the first security processor 121 may determine whether at least a portion of the security functions of the second die 102 are activated from the security status data SSD. As a result, the first security processor 121 may authenticate that the second die 102 has not been replaced, forged, or changed in security status due to an external factor.

Referring to the aforementioned configurations, the first security processor 121 according to some implementations may exchange security messages SM and RSM using the shared key SK stored commonly by the first security processor 121 and the second security processor 122. In addition, the first security processor 121 may verify the security of the second die 102 using the reply security message RSM. As a result, the semiconductor system 100 may prevent the weakening of security caused by replacement or forgery of at least a portion of the dies 101 and 102 due to an external factor. For example, the semiconductor system 100 may improve the security of communication between the dies 101 and 102.

As described above, the first security processor 121 may transmit a security message SM, including an authentication code AC generated using the stored shared key SK, to the second security processor 122.

In addition, the second security processor 122 may determine whether the security message SM has been tampered with, using the authentication code AC included in the security message SM and the prestored shared key SK.

Furthermore, the second security processor 122 may perform a security-required operation based on a command included in a transmitted message when it is determined that a message transmitted from the first die 101 has not been tampered with.

As a result, the semiconductor system 100 may prevent an external attack (for example, hacking) on the communication channel between the dies 101 and 102. For example, the semiconductor system 100 may improve the security of communication between the dies 101 and 102.

In addition, referring to the foregoing configuration, the semiconductor system 100 may ensure the security of communication between the dies 101 and 102 using an authentication code SK without encrypting the data exchanged between the dies 101 and 102.

For example, the semiconductor system 100 may perform communication through the security message SM, including an authentication code AC, to significantly reduce a component (or circuit) required to encrypt all pieces of data (or messages) exchanged between the dies 101 and 102.

As a result, the semiconductor system 100 may operate with relatively less power compared to a case in which all pieces of data (or messages) exchanged between the dies 101 and 102 are encrypted.

In addition, the semiconductor system 100 may be implemented in a relatively smaller area compared to a case in which all pieces of data (or messages) exchanged between the dies 101 and 102 are encrypted.

Also, the semiconductor system 100 may perform communication through the security message SM, including the authentication code AC, to significantly reduce a latency required to encrypt all pieces of data (or messages) exchanged between the dies 101 and 102.

As a result, the semiconductor system 100 may have a relatively less latency compared to a case in which all pieces of data (or messages) exchanged between the dies 101 and 102 are encrypted.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A semiconductor system comprising:
a first die comprising a first security processor and an application processor, the first security processor being configured to store a shared key; and
a second die connected to the first die through a first channel and comprising a second security processor configured to store the shared key,
wherein the application processor is configured to transmit a security request to the first security processor in response to a request for a security-required operation of the second die,
wherein the first security processor is configured to, in response to the security request:
generate an authentication code based on the shared key; and
transmit a security message to the second security processor through the first channel, the security message comprising a command corresponding to the security-required operation of the second die and the authentication code, and
wherein the second security processor is configured to determine that the security message has been tampered with, using the authentication code and the shared key.

2. The semiconductor system of claim 1,
wherein the first security processor comprises a first cryptographic circuit configured to generate the authentication code from the command using the shared key,
wherein the second security processor comprises a second cryptographic circuit configured to generate a decoding code from the command transmitted through the security message using the shared key, and
wherein the second security processor is configured to determine that the security message has not been tampered with, based on the decoding code matching the authentication code.

3. The semiconductor system of claim 2,
wherein the application processor is configured to transmit a first security request to the first security processor in response to a first operation request for a first operation to set a security level of a first intellectual property (IP) block included in the second die,
wherein the first security processor is configured to transmit a first security message to the second security processor in response to the first security request, the first security message comprising a first command corresponding to the first operation, first specific information corresponding to the first IP block, and the authentication code, and
wherein the second security processor is configured to:
determine that the first security message has been tampered with, using the authentication code and the shared key, and
based on determining that the first security message has not been tampered with, set the security level of the first IP block to a first security level based on the first command.

4. The semiconductor system of claim 3,
wherein the application processor is configured to transmit a second security request to the first security processor in response to a second operation request for a second operation to generate a security key for the first IP block,
wherein the first security processor is configured to transmit a second security message to the second security processor in response to the second security request, the second security message comprising a second command corresponding to the second operation, the first specific information, and the authentication code, and
wherein the second security processor is configured to:
determine that the second security message has been tampered with, using the authentication code and the shared key, and
based on determining that the second security message has not been tampered with, generate the security key for the first IP block through the second cryptographic circuit based on the second command.

5. The semiconductor system of claim 2,
wherein the application processor is configured to transmit a third security request and data to the first security processor in response to a third operation request for a third operation to transmit data to a second IP block included in the second die,
wherein the first security processor is configured to transmit a third security message to the second security processor in response to the third security request, the third security message comprising a third command corresponding to the third operation, second specific information corresponding to the second IP block, the data, and the authentication code, and
wherein the second security processor is configured to:
determine that the third security message has been tampered with, using the authentication code and the shared key, and
based on determining that the third security message has not been tampered with, transmit the data to the second IP block based on the third command.

6. The semiconductor system of claim 1,
wherein the application processor is configured to transmit a fourth security request to the first security processor in response to a fourth operation request for verifying the second die,
wherein the first security processor is configured to transmit a fourth security message to the second security processor in response to the fourth security request, the fourth security message comprising a fourth command corresponding to the fourth operation request, an identifier, and the authentication code, and
wherein the second security processor is configured to determine that the fourth security message has been tampered with, using the authentication code and the shared key.

7. The semiconductor system of claim 6,
wherein the second security processor is configured to:
generate a reply authentication code using the shared key based on determining that the fourth security message has not been tampered with; and
transmit a reply security message to the first security processor, the reply security message comprising the reply authentication code, security status data of the second die, and a reply identifier corresponding to the identifier, and
wherein the first security processor is configured to:
determine that the reply security message has been tampered with, using the reply authentication code and the shared key, and
determine that the security status data has not been tampered with, based on determining that the reply security message has not been tampered with and the reply identifier matches the identifier.

8. The semiconductor system of claim 2,
wherein the application processor is configured to transmit a fifth security request to the first security processor in response to a drive request for driving a third IP block included in the second die,
wherein the first security processor is configured to:
load a boot image for the third IP block from memory device in response to the fifth security request; and
transmit a fifth security message to the second security processor, the fifth security message comprising a fifth command corresponding to the drive request, the boot image, third specific information corresponding to the third IP block, and the authentication code, and
wherein the second security processor is configured to:
determine that the fifth security message has been tampered with, using the authentication code and the shared key, and
based on determining that the fifth security message has not been tampered with, drive the third IP block using the boot image based on the fifth command.

9. The semiconductor system of claim 8,
wherein the first security processor is configured to transmit the fifth security message to the second security processor through a second channel that is different from the first channel,
wherein the third IP block comprises a second communication controller connected to a first communication controller of the first die through the first channel, and
wherein the second security processor is configured to drive the second communication controller through the boot image to activate the first channel.

10. The semiconductor system of claim 8, wherein the first security processor is configured to:
verify an electronic signature using a prestored public key and the first cryptographic circuit the electronic signature being included in the boot image; and
generate the fifth security message in response to successful verification of the electronic signature included in the boot image.

11. A method for verifying security, the method comprising:
generating an authentication code, based on a prestored shared key, by a first security processor included in a first die in response to the first die receiving an operation request for a security-required operation of a second die;
transmitting, by the first security processor, a security message to a second security processor included in the second die through a first channel, the security message comprising a command corresponding to the security-required operation and the authentication code;
determining, by the second security processor, that the security message has been tampered with, using a prestored shared key and the authentication code; and
based on determining that the security message has not been tempered with, performing, by the second security processor, the security-required operation based on the command.

12. The method of claim 11, wherein the determining, by the second security processor, that the security message has been tampered with comprises:
generating a decoding code from the command using the authentication code and the shared key; and
determining that the security message has not been tampered with, in response to the decoding code matching the authentication code.

13. The method of claim 12, further comprising:
transmitting a first security message to the second security processor in response to a first operation request for a first operation to set a security level of a first intellectual property (IP) block included in the second die, the first security message comprising a first command corresponding to the first operation, first specific information corresponding to the first IP block, and the authentication code;
determining, by the second security processor, that the first security message has been tampered with, using the authentication code and the shared key; and
based on determining that the first security message has not been tampered with, generating a security key for the first IP block based on the first command.

14. The method of claim 13, further comprising:
transmitting a second security message to the second security processor in response to a second request for a second operation to generate a security key for the first IP block, the second security message comprising a second command corresponding to the second operation, the first specific information, and the authentication code;
determining, by the second security processor, that the second security message has been tampered with, using the authentication code and the shared key; and
based on determining that the second security message has not been tampered with, generating a security key for the first IP block through a cryptographic circuit based on the second command.

15. The method of claim 14, further comprising:
transmitting a third security message to the second security processor in response to a third request for a third operation to transmit data to a second IP block included in the second die, the third security message comprising a third command corresponding to the third operation, second specific information corresponding to the second IP block, the data, and the authentication code;
determining, by the second security processor, that the third security message has been tampered with, using the authentication code and the shared key; and
based on determining that the third security message has not been tampered with, transmitting the data to the second IP block based on the third command.

16. The method of claim 13, further comprising:
transmitting a fourth security message to the second security processor in response to an authentication request for the second die, the fourth security message comprising a fourth command corresponding to the authentication request, an identifier, and the authentication code;
determining, by the second security processor, that the fourth security message has been tampered with, using the authentication code and the shared key;
generating a reply authentication code using the shared key based on determining that the fourth security message has not been tampered with; and
transmitting a reply security message to the first security processor, the reply security message comprising the reply authentication code, security status data of the second die, and a reply identifier corresponding to the identifier.

17. The method of claim 16, further comprising:
determining, by the second security processor, that the reply security message has been tampered with, using the reply authentication code and the shared key; and
based on determining that the reply security message has not been tampered with and the reply identifier matches the identifier, determining that the second die has security based on the security status data.

18. A system-on-chip (SoC) comprising a plurality of dies connected to each other through a substrate, the SoC comprising:
a first die comprising a first security processor and an application processor, the first security processor being configured to store a shared key; and
a second die connected to the first die through a first channel and comprising a second security processor configured to store the shared key,
wherein the application processor is configured to transmit a first security request to the first security processor in response to a first operation request for a first operation to set a security level of a first intellectual property (IP) block included in the second die,
wherein the first security processor is configured to, in response to the first security request:
generate an authentication code based on the shared key;
generate a first security message comprising a first command corresponding to the first operation and the authentication code; and
transmit the first security message to the second security processor through the first channel, and
wherein the second security processor is configured to determine that the first security message has been tampered with, using the authentication code and the shared key.

19. The SoC of claim 18,
wherein the first security processor comprises a first cryptographic circuit configured to generate the authentication code from the first command using the shared key,
wherein the second security processor comprises a second cryptographic circuit configured to generate a decoding code from the first command included in the first security message using the shared key, and
wherein the second security processor is configured to determine that the security message has not been tampered with, based on the decoding code matching the authentication code.

20. The SoC of claim 18, wherein the second security processor is configured to:
set a security level of the first IP block to a first security level in response to determining that the first security message has not been tampered with; and
transmit result data to the application processor through the first channel, the result data comprising information indicating that the security level of the first IP block is the first security level.
